(19) United States
(12) Patent Application Publication
(10) Pub. No.: US 2006/0080705 A1
(43) Pub. Date: Apr. 13, 2006

(54) Broadcast receiver, video signal output apparatus and broadcast receiving method

(75) Inventor: Akira Miyazawa, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/225,130

(22) Filed: Sep. 14, 2005

(30) Foreign Application Priority Data
Sep. 27, 2004 (JP) 2004-280479

(51) Int. Cl. H04N 5/445; G06F 3/00; G06F 13/00

(52) U.S. Cl. 725/37; 348/563; 725/39

(57) ABSTRACT

A broadcast receiver comprising a screen for displaying an operation panel, a light receiving unit for receiving operation information transmitted from a remote controller having a first cursor key composed of a plurality of cursor buttons respectively corresponding to different directions within the screen, and a second cursor key composed of a plurality of operation buttons different from the cursor buttons, a detection unit for detecting operations of the second cursor key, and a display control unit for switching pages in directions corresponding to the operation buttons of the second cursor key in response to content displayed on the screen.

### CROSS-REFERENCE TO RELATED APPLICATIONS

This application is based upon and claims the benefit of priority from prior Japanese Patent Application No. 2004-280479, filed Sep. 27, 2004, the entire contents of which are incorporated herein by reference.

### BACKGROUND OF THE INVENTION

1. Field of the Invention

The present invention relates to a broadcast receiver, a video signal output apparatus, and improvement in their receiving method for receiving, for example, digital television broadcast.

2. Description of the Related Art

As is well known, in recent years, acceleration of digitization of television broadcast has become promoted. For example, in Japan, not only satellite digital broadcast such as broadcasting satellite (BS) digital broadcast and 110° communication satellite (CS) digital broadcast but also terrestrial digital broadcast has been started.

It has become possible for a digital broadcast receiver for receiving such digital television broadcast to digitally record the received program or reproduce the recorded program by connecting digital recording equipment with a large capacity such as a hard disk drive (HDD).

Nowadays, it is possible for the digital broadcast receiver to specify any digital recording equipment for recording a program and reproducing the recorded program by connecting a plurality of sets of digital recording equipment to a single digital broadcast receiver to configure a network.

A remote control system capable of enhancing a degree of freedom of design for a graphic user interface (GUI) screen to be operated by a remote controller is disclosed in Jpn. Pat. Appln. KOKAI Publication No. 2000-112614.

A pointing input device and electronic equipment having this input device which eliminates the need of a plurality of operation buttons and improves the operability and miniaturizes its size by making a plurality of targets to be operated be smoothly operated only by one finger are disclosed in Jpn. Pat. Appln. KOKAI Publication No. 9-134248.

By the way, in the broadcast receiver making the plurality of sets of the digital recording equipment connectable to a network, it becomes important to allow a user to easily manage programs recorded in each respective digital recording equipment and quickly retrieve the desired recorded program to reproduce it.

Therefore, for the digital broadcast receiver to which the plurality of sets of the digital recording equipment (so-called external equipment) can be connected with a network, it is preferable to be able to control the external equipment connected to the broadcast receiver while watching the screen thereof. For establishing this desire, an operation panel is displayed on the screen of the broadcast receiver and a GUI environment is formed. The user operates the remote controller while watching the operation panel. The user operates a cursor key to move the cursor on the screen onto the desired operation key on the screen and operates an enter key. Thereby, the desired operation mode is set to the broadcast receiver and the external equipment.

However, when the user displays the GUI to operate the remote controller, since it is required to operate step by step such as cursor movement and an operation of the enter key through the operations of the cursor key, the required operations become complicate. In particular, a user interface has become complicate in association with multi-functionality of a recent broadcast receiver, for an application of a program table, etc., and digital recording onto the HDD. In contrast, an existing digital broadcast receiver only has functions to basically operate a cursor button, an enter button and a return button of a remote controller and becomes weak to be compatible with a complicate interface in recent years.

### BRIEF SUMMARY OF THE INVENTION

According to an aspect of the present invention, there is provided a broadcast receiver comprising a screen for displaying an operation panel; a light receiving unit for receiving operation information transmitted from a remote controller having a first cursor key composed of a plurality of cursor buttons respectively corresponding to different directions within the screen, and a second cursor key composed of a plurality of operation buttons different from the cursor buttons; a detection unit for detecting operations of the second cursor key; and a display control unit for switching pages in directions corresponding to the operation buttons of the second cursor key in response to content displayed on the screen.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for schematically explaining an example of a digital television broadcast receiver and a network configured around the broadcast receiver as a center;

FIG. 2 is a block diagram for explaining a main signal processing system of the broadcast receiver in an embodiment of the present invention;

FIG. 3 is an exterior appearance view for explaining a remote controller of the broadcast receiver in the embodiment of the present invention;

FIG. 4 is a view showing an example of an electronic program table displayed at a digital television broadcast receiver 11 in FIG. 1;

FIG. 5 is a flowchart showing a first processing function of a control unit 56 in FIG. 2;

FIG. 6 is a view showing an example of a screen displayed from a screen in FIG. 4 when a “V” button of a page switching key 17i is depressed;

FIG. 7 is a view showing an example of a navigation screen;

FIG. 8 is a view showing an example of a list screen of a recently recoded program;

FIG. 9 is a flowchart showing a second processing function of the control unit 56 in FIG. 2;

FIG. 10 is a view for explaining a photograph reproducing function and a cue function of the broadcast receiver 11 in FIG. 1; and

FIG. 11 is a flowchart showing a third processing function of the control unit 56 in FIG. 2.

### DETAILED DESCRIPTION OF THE INVENTION

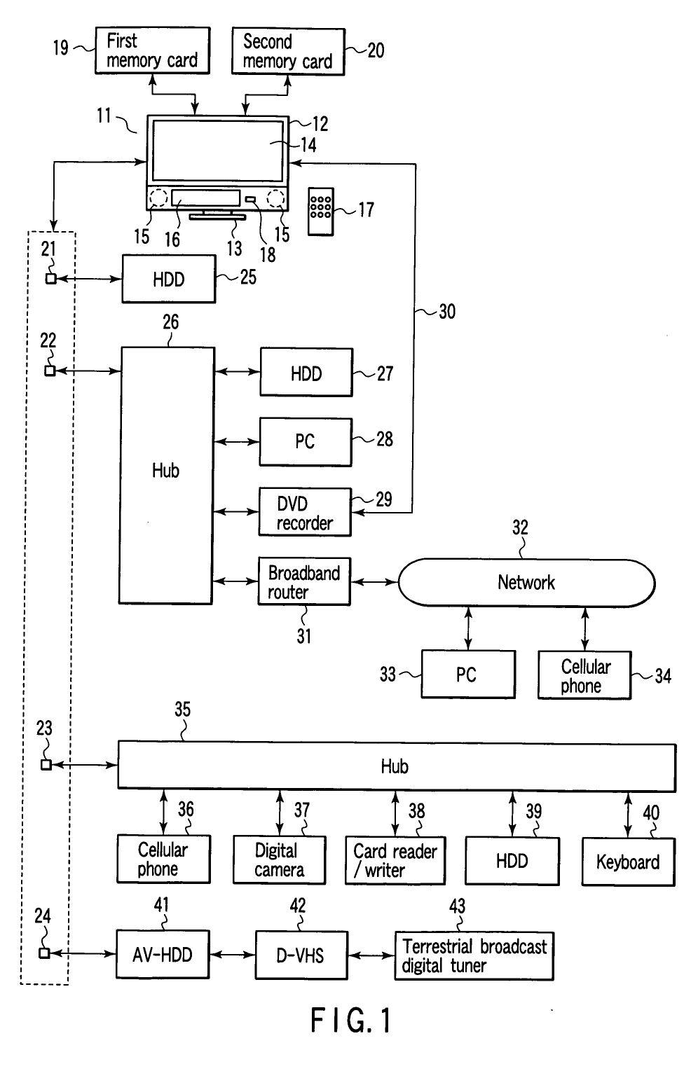

Hereinafter, embodiments of the present invention will be explained by referring the drawings in details. FIG. 1 schematically shows an external appearance of a digital television broadcast receiver 11 which will be explained in the embodiments and an example of a network system configured around the broadcast receiver 11 as a center.

Otherwise stated, the broadcast receiver 11 composed mainly of a thin cabinet 12 and a support stand 13 for making the cabinet 12 raised and supported. The cabinet 12 is provided with a flat panel type video display unit 14 composed of a liquid crystal display panel or the like, a loud speaker 15, an operation unit 16 and a light receiving unit 18 and the like for receiving operation information transmitted from a remote controller 17.

The broadcast receiver 11 detachably has a first memory card 19 such as a secure digital (SD) memory card, a multimedia card (MMC) and a memory stick and performs recording/reproducing of information about a program, a photograph and the like to and from the first memory card 19.

The broadcast receiver 11, further, detachably has a second memory card (IC card) 20 with, for example, contract information recorded thereon and performs recording/reproducing of information to and from the second memory card 20.

The broadcast receiver 11 is provided with a first local area network (LAN) terminal 21, a second LAN terminal 22, a universal serial bus (USB) terminal 23 and an i.Link (trade mark) terminal 24.

Among these terminals 21-24, the first LAN terminal 21 is used as a LAN-compatible HDD-dedicated port. The first LAN terminal 21 is connected to a LAN-compatible HDD 25 being a network attached storage (NAS). The first LAN terminal 21 is used to record/reproduce information to and from the HDD 25 through Ethernet (registered trade mark), wherein the HDD 25 is a LAN-compatible one and is a connected network attached storage (NAS).

As mentioned above, by providing the first LAN terminal 21 to be the LAN-compatible HDD dedicated port, the broadcast receiver 11 can stably performs information recording with a high image quality of a program to the HDD 25 without being influenced by other network environments or a status of use of the network. The second LAN terminal 22 is used as a general LAN-compatible port using the Ethernet. The second LAN terminal 22 is connected to equipment, for example, a LAN-compatible HDD 27, a personal computer (PC) 28 and a digital versatile disk (DVD) recorder 29 with a built-in HDD through a hub 26 via and used in information transmission between the equipment and the broadcast receiver 11.

Since digital information communicated through the second LAN terminal 22 is information of a control system, the DVD recorder 29 requires a dedicated analog transmission path 30 to transmit analog information of video and sound to the broadcast receiver 11. The second LAN terminal 22 is connected to, to a network 32 such as the Internet via a broadband router 31 connected to the hub 26 and used to communicate information with a PC 33 or a cellular phone 34, etc., via the network 32.

The USB terminal 23 is used as a general USB-compatible port, connected to equipment such as a cellular phone 36, a digital camera 37, a card reader/writer 38 for a memory card, an HDD 39 and a keyboard 40 and used to make information transmission between this equipment and the broadcast receiver 11.

The i.Link terminal 24 is used to serially connects an AV-HDD 41, digital (D)—video home system (VHS) 42, etc., and to make the information transmission between this equipment and the broadcast receiver 11.

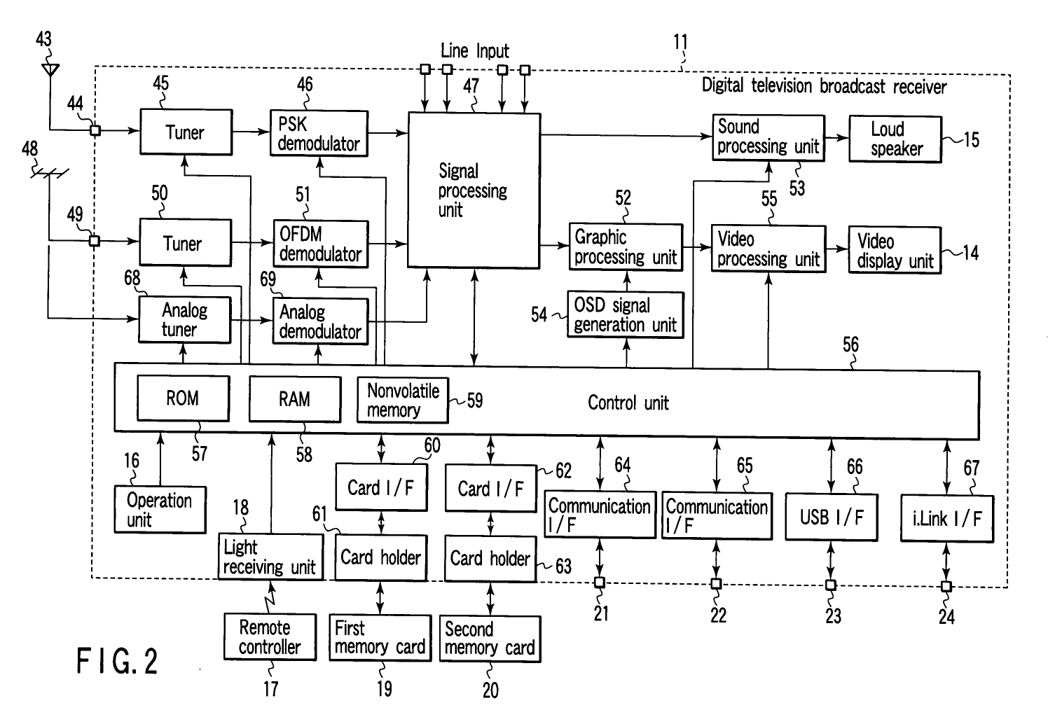

FIG. 2 shows the principal signal processing system of the broadcast receiver 11 in FIG. 1. That is, a satellite digital television broadcast signal received at an antenna 43 for receiving BS/CS digital broadcast is supplied to a tuner 45 for satellite digital broadcast through an input terminal 44, and the tuner 45 tunes a broadcast signal of a desired channel.

The broadcast signal tuned by the tuner 45 is fed to a phase shift keying (PSK) demodulator 46 to be demodulated to a digital video signal and a digital sound signal then output to a signal processor 47.

A terrestrial digital television broadcast signal received at an antenna 48 for receiving terrestrial digital television broadcast is supplied to a tuner 50 for the terrestrial digital television broadcast via an input terminal 49, and the tuner 50 tunes the broadcast signal of the desired channel. The broadcast signal tuned by the tuner 50 is fed to an orthogonal frequency division multiplexing (OFDM) demodulator 51 to be demodulated to a digital video signal and a digital sound signal then output to the signal processor 47.

The signal processor 47 selectively conducts prescribed digital signal processing to the digital video signals and sound signals supplied from the PSK demodulator 46 and from the OFDM demodulator 51 and conducts to the video signals and analog signals supplied from the analog demodulator 69 and further from the line input terminals, and outputs output signals to a graphic processor 52 and a sound processor 53.

Among the processors, the graphic processor 52 has a function to superimpose an on screen display (OSD) signal generated from an OSD signal generator 54 on the digital video signal supplied from the signal processor 47 and output the superimposed signal. The graphic processor 52 can selectively output the video signal output from the signal processor 47 and the OSD signal output from the signal generator 54 and also combine to output both outputs so that they configure a half of a screen, respectively.

The digital video signal output from the graphic processor 52 is supplied to a video processor 55. The video processor 55 converts the input digital video signal into an analog video signal in a format possible to be displayed on the video display unit 14 and outputs the converted analog video signal to the video display unit 14 to make a video display.

A sound processor 53 converts the input digital sound signal into an analog sound signal in a format possible to be reproduced by the loud speaker 15 and outputs the analog sound signal to the loud speaker 15 to make a sound reproduction.

Wherein, the broadcast receiver 11 integrally controls the whole operations including the above-mentioned various types of receiving operations by means of a control unit 56. The control unit 56 has a built-in central processing unit (CPU), etc., receives operation information from the operation unit 16, or receives operation information transmitted from the remoter controller 17 and respectively controls each part so as to reflect operation contents thereto.

In this case, the control unit 56 mainly utilizes a read only memory (ROM) 57 with a control program to be executed by the CPU stored thereon, a random access memory (RAM) 58 to provide an operation area to the CPU and a nonvolatile memory 59 to which a variety of items of setting information and control information is stored.

The control unit 56 is connected to a card holder 61 to which the first memory 19 can be attached through a card interface (I/F) 60. The control unit 56, thereby can perform an information transmission to the first memory card 19 attached to the card holder 61, through the card I/F 60.

The control unit 56 is further connected to a card holder 63 to which a second memory card 20 can be attached through a card I/F 62. The control unit 56 thereby can perform an information transmission to the second memory card 20 attached to the card holder 63, through the card I/F 62.

The control unit 56 is also connected to the first LAN terminal 21 through a communication I/F 64. The control unit 56 thereby can perform an information transmission to the LAN-compatible HDD 25 connected to the first LAN terminal 21, through the communication I/F 64. In this case, the control unit 56 has a dynamic host configuration protocol (DHCP) server function and assigns an internet protocol (IP) address to the LAN compatible HDD 25 connected to the first LAN terminal 21 to control the HDD 25.

The control unit 56 is further connected to the second LAN terminal 22 through a communication I/F 65. The control unit thereby can perform information an information transmission to each equipment (refer to FIG. 1) connected to the second LAN terminal 22, through the communication I/F 65.

The control unit 56 is connected to the USB terminal 23 through an USB I/F 66. The control unit 56 thereby can perform an information transmission to each equipment (refer to FIG. 1) connected to the USB terminal 23, through the USB I/F 66. The control unit 56 further connected to the i.Link terminal 24 through an i.Link I/F 67. Thereby, the control unit 56 can perform an information transmission to each equipment (refer to FIG. 1) connected to the i.Link terminal 24, through the i.Ling I/F 67.

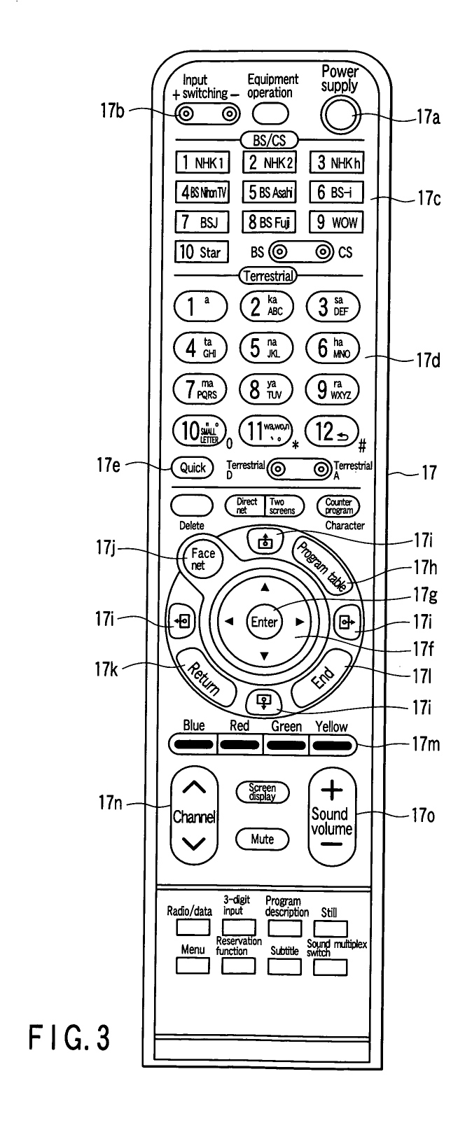

FIG. 3 shows the external view of the remote controller 17. The remote controller 17 mainly comprises a power supply key 17a, input switching keys 17b, direct tuning keys for satellite broadcast channels 17c, direct tuning keys of terrestrial broadcast channels 17d, a quick key 17e, a cursor key 17f, an enter key 17g, a program table key 17h, page switching keys 17i, a facenet (trade mark) (navigation) key 17j, a return key 17k, an end key 171, color keys in blue, red, green and yellow 17m, a channel up down key 17n, a sound volume adjusting key 17o, etc.

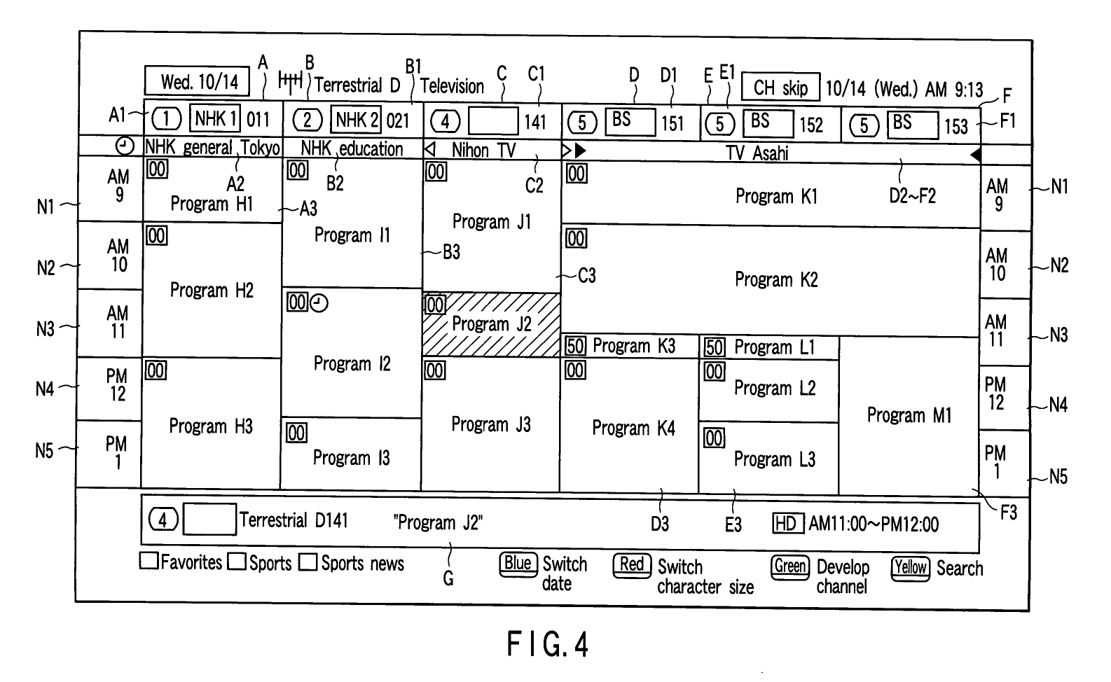

FIG. 4 is the view showing one example of the electronic program table displayed at the broadcast receiver 11. This program table displays programs by arranging six broadcast stations (channels) in lateral directions and time frames of five hours in longitudinal directions. Then, the program table can be selectively scrolled in right and left or up and down directions by operating the cursor key 17f of the remote controller 17. When the page switching key 17i of the remote controller 17 is operated, the program table of one screen can be selectively skipped in the right and left or up and down directions.

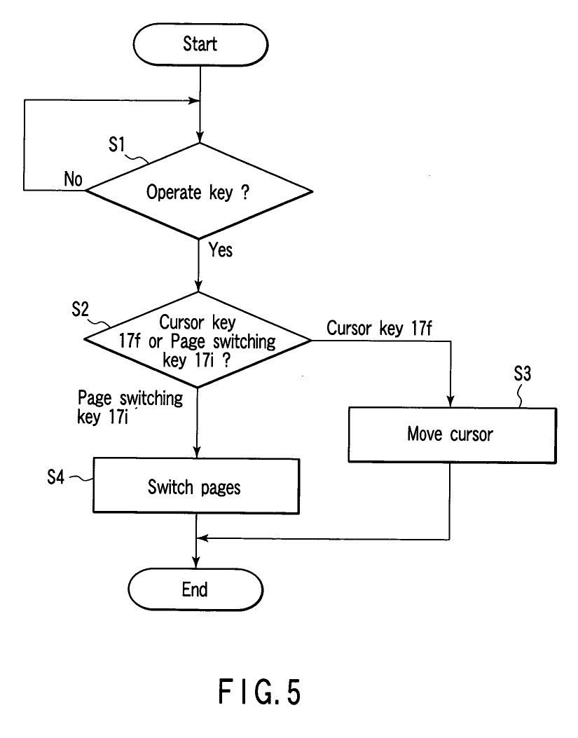

FIG. 5 is the flowchart showing the processing function of the control unit 56 in FIG. 2. The control unit 56 waits for key operations of the remote controller 17 (step S1). When the key operations are performed, the control unit 56 determines whether or not the cursor key 17f is depressed or the page switching key 17i is depressed (step S2). If the cursor key 17f is depressed, the control unit 56 moves the cursor within the screen in FIG. 4. The position of the cursor in FIG. 4 is indicated by hatching (program J2).

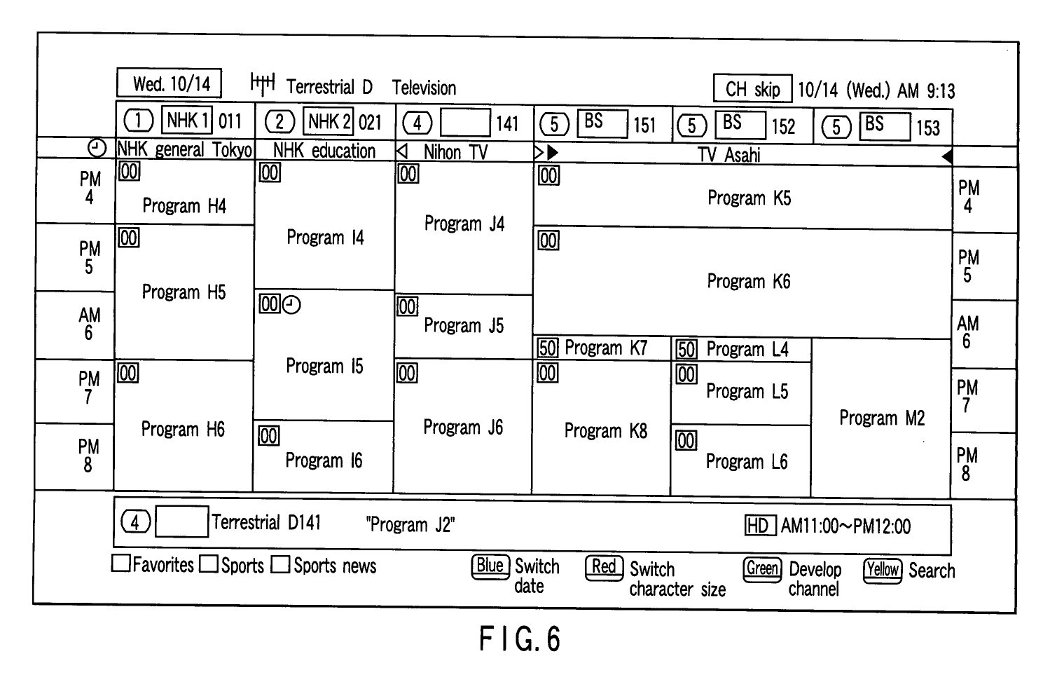

In contrast, if the page switching key 17i is depressed in step S2, the control unit 56 switches the pages of the program table (step S4). For example, if the “V” button of the page switching key 17i is depressed, the control unit 56 switches the pages of the program table in time directions. Thereby, the screen shown in FIG. 6 is displayed from the screen in FIG. 4. FIG. 6 shows content in the future in term of time in comparison with FIG. 4. Accordingly, the “V” button switches the pages in the directions to make time progress. The button “A” switches the pages to get time back. The buttons “<” and “>” switch the pages to display channels. As given above, in applications of longitudinal and lateral configuration such as a program table, the page switching key 17i can be used as the page switching key in the longitudinal and lateral directions.

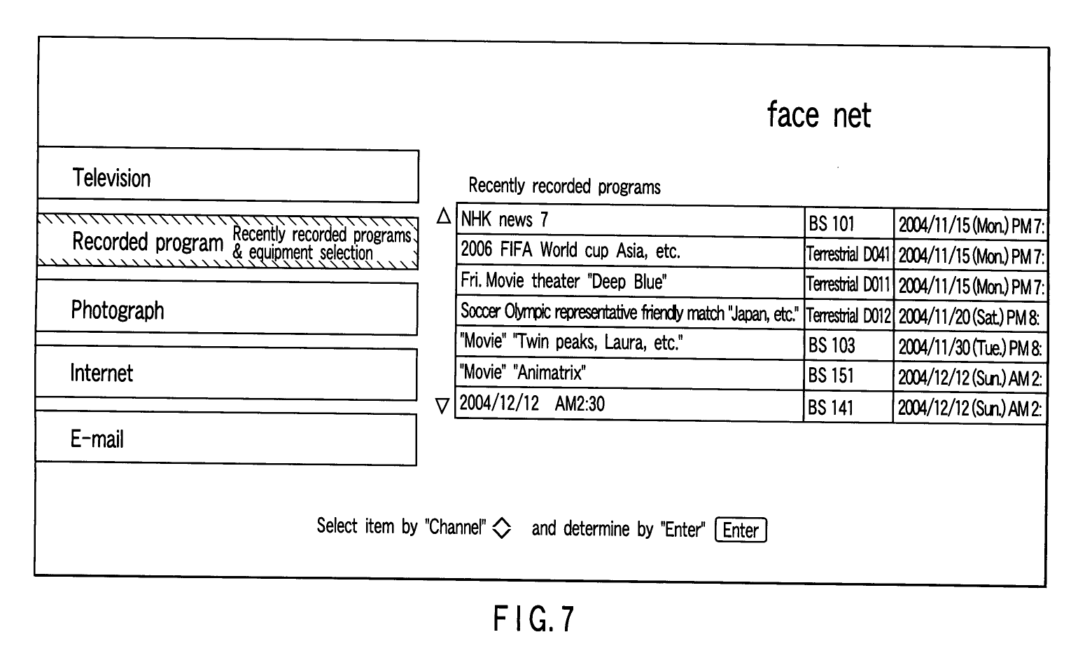

When the facenet key 17j of the remote controller 17 is operated, the control unit 56 starts up the facenet (navigation) and displays the navigation menu as shown in FIG. 7 onto the video display unit 14. Five items of “television”, “recorded program”, “photograph”, “Internet” and “e-mail” are selectively provided in this menu by operating the cursor key 17f of the remote controller 17. The selected item is displayed on the screen in different color from those of other not selected items, and a state with the item of “recorded program” selected therein is indicated by hatching in FIG. 7.

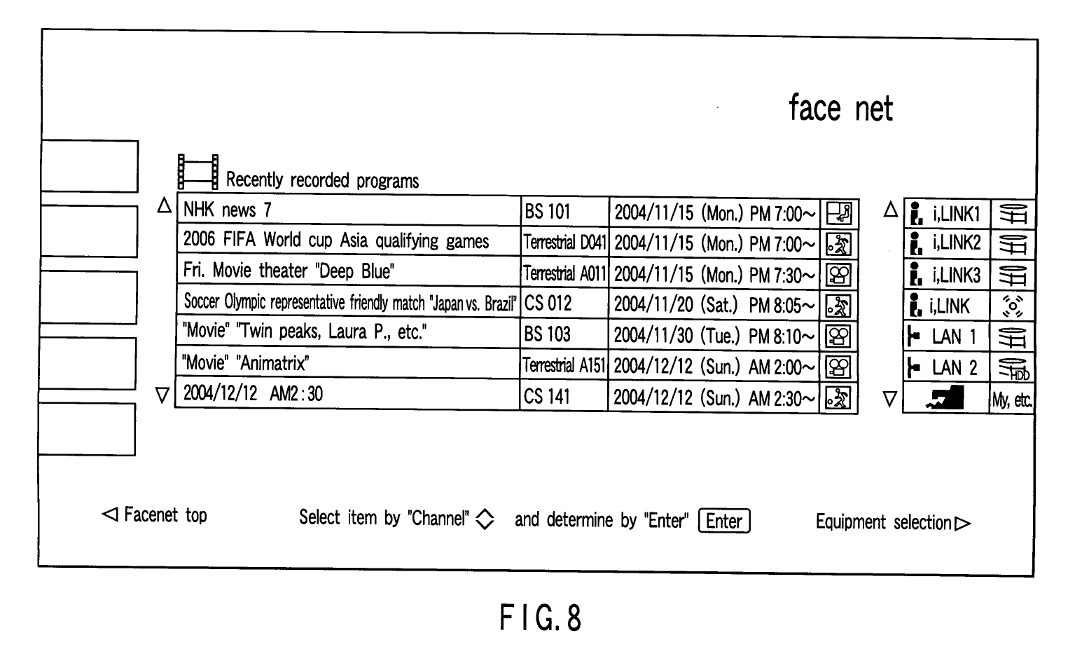

In this state, when the user operates the enter key 17g of the remote controller 17, the control unit 56 displays a list of the recently recorded programs onto the video display unit 14 as shown in FIG. 8. In this program list, the title, broadcast channel, recording date, day of the week, time, category, etc., are displayed onto a variety of sets of recording equipment connected to the broadcast receiver, as information indicating the recorded program.

In this list of the programs recently recorded, it is possible to display information indicating thirty-five programs at a maximum as far back as the most recently recorded program, regardless of the recording equipment with the program recorded therein. Having displayed seven programs in a list form in FIG. 8, the user can view the list of thirty-five programs by operating the cursor key 17f to scroll the display. When operating the cursor key 17f of the remote controller 17, the user can skip the seven programs displayed in a list at once. As stated above, in a list display application, the user can utilize the page switching key 17i as the page switching key to switch the pages in the longitudinal directions or the lateral directions.

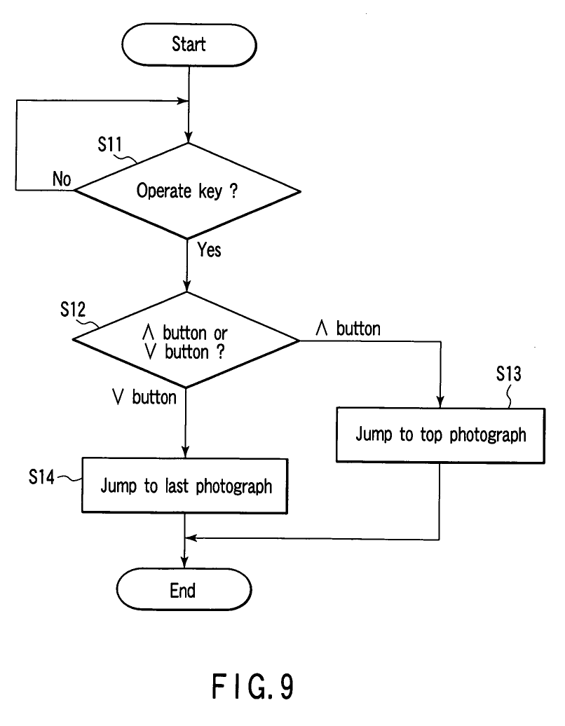

FIG. 9 is the flowchart showing the second processing function of the control unit 56 in FIG. 2. This flowchart is executed in the case of display of a plurality of objects on the screen of the broadcast receiver 11 and in the case of implementation of jump to the last object. Here, a static image (photograph) in a joint photographic experts group (JPEG) format is taken as an example.

The control unit 56 waits for operations of the page switching key 17i of the remote controller 17 (step S11). When the key operation is performed, the control unit 56 determines which of the “Λ” button or the “V” button is depressed (step S12). If the “Λ” button is depressed, the implementation of jump to the top image among images arranged at a plurality of lines in the screen is conducted (step S13). Namely, the control unit 56 brings about a shift to a state of selection of the top image. If the “V” button is depressed, the control unit 56 brings about jump to the last image (step S14).

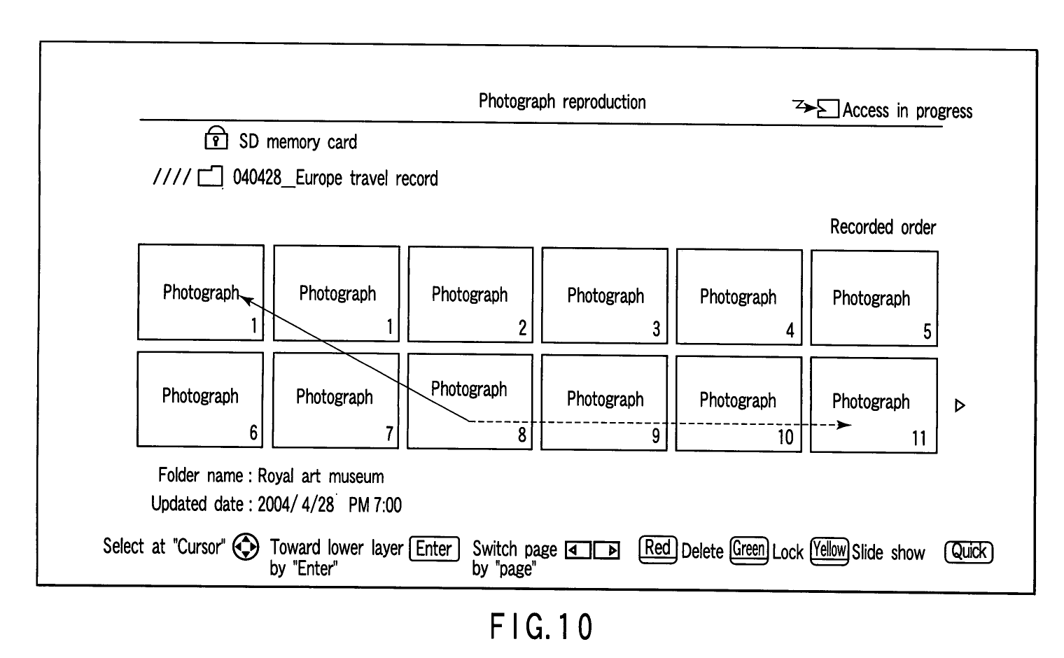

As shown in FIG. 10, the broadcast receiver 11 has a function to display photographs captured from the memory card 19, etc., in a list. For example, in the state of selection of the photograph number 8, if the “A” button is depressed, the screen shifts to a state of selection of the number 0 photograph (arrow by full line in FIG. 10). If the “V” button is depressed, the screen shifts to a state of selection of the number 11 photograph (arrow by dot line in FIG. 10).

In such an application to display a plurality of objects in a list, the page switching key 17i can be utilized as a functional key for cueing.

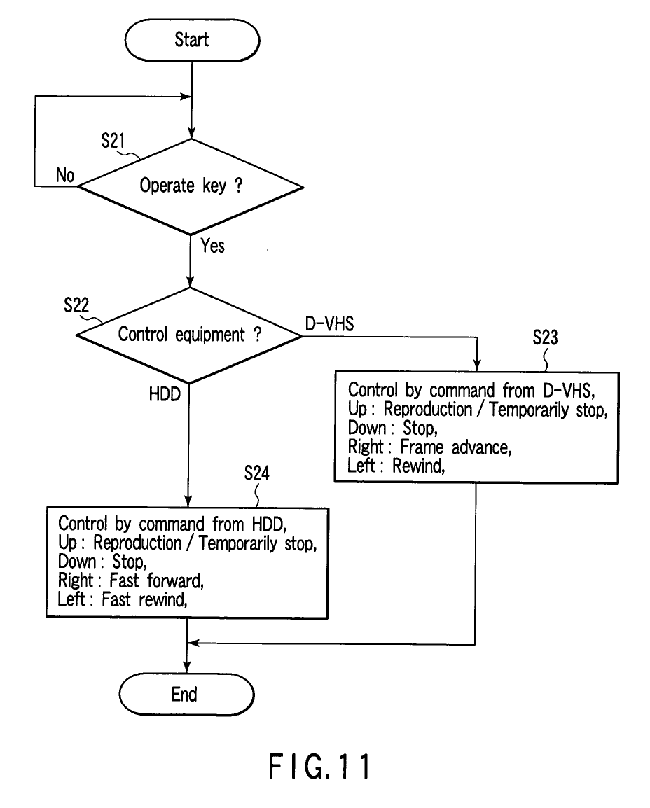

FIG. 11 is the flowchart showing the third processing function of the control unit 56 in FIG. 2. The control unit 56 waits for operations of the page switching key 17i of the remote controller 17 (step S21). When the page switching key 17i is operated, the control unit 56 distinguishes equipment to be controlled being an operation target (step S22). The equipment to be controlled is external equipment such as HDD 27 and PC 28, here, the HDD 27 and the digital-VHS (D-VHS) (not shown) are taken as examples.

The control unit 56 inputs control commands corresponding to the distinguished equipment, respectively, through the hub 26. If the equipment is the D-VHS, “V”, “Λ”, “>” and “<” buttons correspond to “reproduction/temporary stop”, “stop”, “frame advance” and “rewind”, respectively. If the equipment is the HDD 27, the “>” and “<” buttons correspond to “fast forward” and “fast rewind”, respectively. In this manner, the page switching key 17i can be also used as a remote control key to control the external equipment. Since this manner eliminates the need for using a remote controller terminal dedicated for respective external equipment, the remote controller 17 becomes excellent in usability. The page switching keys 17i other than the key 17i used as the remote control key to control the external equipment can be utilized for other purpose by assigning functions required at every application.

The present invention is not limited to the above embodiments. For example, the invention may be applied to a set top-box (STB). The set top-box is widely used to output a video signal to a display apparatus, such as the video display unit 14.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiver comprising:
a screen for displaying an operation panel;
a light receiving unit for receiving operation information transmitted from a remote controller having a first cursor key composed of a plurality of cursor buttons respectively corresponding to different directions within the screen, and a second cursor key composed of a plurality of operation buttons different from the cursor buttons;
a detection unit for detecting operations of the second cursor key; and
a display control unit for switching pages in directions corresponding to the operation buttons of the second cursor key in response to content displayed on the screen.

2. The broadcast receiver according to claim 1, wherein the display control unit switches the pages in longitudinal directions and lateral directions in response to the operation buttons of the second cursor key, in a state that table information divided into the longitudinal directions and the lateral directions is displayed on the screen.

3. The broadcast receiver according to claim 1, wherein the display control unit displays a state in which a specific object corresponding to the top or the last of a plurality of objects in response to the operation buttons of the second cursor key, in a state that a list of the plurality of objects is displayed on the screen.

4. The broadcast receiver according to claim 1, if external equipment is connected thereto, the broadcast receiver further comprising a command input means for inputting commands corresponding to the plurality of operation buttons of the second cursor key by associating the operation buttons with a control command to the external equipment.

5. A video signal output apparatus comprising:
a light receiving unit for receiving operation information transmitted from a remote controller having a first cursor key composed of a plurality of cursor buttons respectively corresponding to different directions within a screen, and a second cursor key composed of a plurality of operation buttons different from the cursor buttons;
a detection unit for detecting operations of the second cursor key; and
a display control unit for switching pages in directions corresponding to the operation buttons of the second cursor key in response to content displayed on the screen.

6. The video signal output apparatus according to claim 5, wherein the display control unit switches the pages in longitudinal directions and lateral directions in response to the operation buttons of the second cursor key, in a state that table information divided into the longitudinal directions and the lateral directions is displayed on the screen.

7. The video signal output apparatus according to claim 5, wherein the display control unit displays a state in which a specific object corresponding to the top or the last of a plurality of objects in response to the operation buttons of the second cursor key, in a state that a list of the plurality of objects is displayed on the screen.

8. The video signal output apparatus according to claim 5, if external equipment is connected thereto, the broadcast receiver further comprising a command input means for inputting commands corresponding to the plurality of operation buttons of the second cursor key by associating the operation buttons with a control command to the external equipment.

9. A broadcast receiving method used for a broadcast receiver to be operated through a remote controller having a cursor key composed of a plurality of cursor buttons respectively corresponding to different directions within a screen, if the remote controller has a second cursor key composed of a plurality of operation buttons different from the cursor buttons, the receiving method comprising:
a detecting step of detecting operations of the second cursor key; and
a switching step of switching pages in directions corresponding to operation buttons of the second cursor key in response to content displayed on the screen.

10. The broadcast receiving method according to claim 9, wherein the switching step includes a step of switching the pages in longitudinal directions and lateral directions in response to the operation buttons of the second cursor key, in a state that table information divided into the longitudinal directions and the lateral directions is displayed on the screen.

11. The broadcast receiving method according to claim 9, wherein the switching step includes a step of displaying a state in which a specific object corresponding to the top or the last of a plurality of objects in response to the operation buttons of the second cursor key, in a state that a list of the plurality of objects is displayed on the screen.

12. The broadcast receiving method according to claim 9, when external equipment is connected to the broadcast receiver, the receiving method further comprising a command input step of inputting commands corresponding to the operation buttons of the second cursor key by associating the plurality of operation buttons with a control command to the external equipment.
